(19) United States
(12) Patent Application Publication
(10) Pub. No.: US 2006/0096670 A1
(43) Pub. Date: May 11, 2006

(54) Low-frequency magnetic screening made from a soft magnetic alloy

(75) Inventors: Thierry Waeckerle, Nevers (FR); Herve Fraisse, Nevers (FR); Sylvain Witzke, Sauvigny Les Bois (FR); Bruno Boulogne, Sechoise (FR)

Correspondence Address: SUGHRUE MION, PLLC, 2100 PENNSYLVANIA AVENUE, N.W., SUITE 800, WASHINGTON, DC, 20037, US

(73) Assignee: Imphy Alloys

(21) Appl. No.: 10/504,698

(22) PCT Filed: Feb. 14, 2003
(86) PCT No.: PCT/FR03/00491

§ 371 Date: Mar. 10, 2005

(30) Foreign Application Priority Data
Feb. 15, 2002 (FR) 02/01901

(51) Int. Cl. H01F 1/147

(52) U.S. Cl. 148/310

(57) ABSTRACT

The invention relates to a magnetic screening for frequency fields between 50 Hz and 3000 Hz, made from a soft magnetic alloy of the following composition in wt. %: 30%≦Ni≦40%, 0%≦Cu+Co≦4%, 5%≦Cr+Mo≦17%, 5%≦Cr 0%≦Nb≦2%, Mn≦0.35%, Si≦0.2%, C≦0.050%, O≦0.0160%, S≦0.0020%, B≦0.0010%, optionally at least one element selected from magnesium and calcium in amounts such that the sum thereof remains below 0.1 %, the rest being iron and production impurities. The chemical composition furthermore satisfies the following relationships: Cr+Mo≦0.8×Ni+0.9×(Co+Cu) 18.4; Cr+Mo≦4×Ni+3×(Co+Cu)−124; 4×(Cr+Mo)≧125−3×Ni. The invention further relates to use of said alloy for the production of low-frequency magnetic screening.

The present invention relates to low-frequency magnetic shielding made from a soft magnetic alloy and to the use of this alloy for the production of low-frequency shielding. In the context of the present invention, the term “low-frequency” denotes frequencies between 50 Hz and 3000 Hz.

Magnetic shielding is produced from a high-permeability magnetic alloy and, in particular, from an alloy of the Fe—Ni80 type containing approximately 80% of nickel. They have permeability in a direct field μ_{cc} of more than 100000 and permeability in an alternating field at 300 Hz, μ_{300 Hz} of more than 10000. Furthermore, these alloys have a coercive field Hc of less than 20 mOe and saturation induction Bs of more than 6000 Gauss. However, these alloys are very expensive as they have a high nickel content.

Alloys of the Fe—Ni36 type containing approximately 36% of nickel are used to produce less expensive shielding. However, these alloys have permeability in a direct field μ_{cc} between only 20000 and 30000 and permeability in an alternating field at 300 Hz, μ_{300 Hz} between 8000 and 9000, a coercive field Hc between 50 and 100 mOe and saturation induction Bs of approximately 13000 Gauss. With these magnetic properties the shielding obtained is less effective than shielding produced from Fe—Ni80 alloy.

It has also been proposed, for example in U.S. Pat. No. 5,158,624, to use an alloy containing 35 to 40% of nickel and 5 to 14% of chromium, the remainder being iron and impurities and the composition satisfying the relationships 3×Ni−5×Cr≦80 and Ni−Cr≧25. Furthermore, the contents of oxygen, sulphur and boron have to be strictly controlled; in particular the oxygen content has to be kept at less than 0.005%. In addition, the alloy contains 0.5% manganese, approximately 0.2% of silicon, approximately 0.01% of aluminum. This alloy has permeability in an alternating field at 300 Hz, μ_{300 Hz} of between 9400 and 14900, a coercive field Hc between 10 and 80 mOe and saturation induction Bs between 5000 G and 8200 G.

This alloy has the advantage of having higher permeability μ_{300 Hz} than the alloy Fe—Ni36 and of containing chromium, and this gives it some resistance to corrosion, but its better permeability may only be obtained with very low oxygen contents, and this restricts the production thereof. In addition, it would be desirable to have an inexpensive alloy having even better magnetic permeability.

The object of the present invention is to propose an inexpensive soft magnetic alloy, which is suitable for the production of low-frequency magnetic shielding, is more effective and less restrictive to produce than known alloys.

The invention accordingly relates firstly to magnetic shielding for frequency fields between 50 Hz and 3000 Hz, made from a soft magnetic alloy of the following composition in % by weight:
30%≦Ni≦40%
0%≦Cu+Co≦4%
5%≦Cr+Mo≦17%
5%≦Cr
0% ≦Nb≦2%
Mn≦0.35%
Si≦0.2%
C≦0.050%
O≦0.0160%
S≦0.0020%
B≦0.0010%,
optionally at least one element selected from magnesium and calcium in amounts such that the sum thereof remains below 0.1%, the remainder being iron and production impurities, the chemical composition furthermore satisfying the following relationship:
Cr+Mo≦0.8×Ni+0.9×(Co+Cu)−18.4
Cr+Mo≦4×Ni+3×(Co+Cu)−124
4×(Cr+Mo)≧125−3×Ni.

Preferably, it is preferable for the silicon content to be less than 0.15%, for the manganese content to be more than 0.05%, and for the sum of cobalt and copper contents to be more than 0.015%. The oxygen content may be more than 0.0050%.

The invention will now be described in more detail and illustrated by examples.

The alloy according to the invention contains the following, in % by weight:
more than 30% of nickel for obtaining good magnetic properties and, in particular, adequate magnetic permeability and saturation induction, but less than 40%, because nickel is an expensive element and, above 40%, does not improve the desired magnetic properties;
one or more elements selected from copper and cobalt, the sum of their contents being between 0% and 4% and preferably more than 0.015%, and more preferably more than 0.5%, and yet more preferably more than 1% to increase the saturation induction Bs and obtain high magnetic permeability when the nickel content is relatively low;
one or more elements selected from chromium and molybdenum, the sum of their contents being between 5% and 17%, and the chromium content being more than 5%. These elements increase the magnetic permeability and reduce the coercive field, providing the contents thereof are not too high. Furthermore, to obtain the desired magnetic properties, namely Bs>4000 G at 40° C. and good magnetic permeability, the Cr, Mo, Ni, Cu and Co contents have to be such that:
   Cr+Mo≦0.8×Ni+0.9×(Co+Cu)−18.4
   and Cr+Mo≦4×Ni+3×(Co+Cu)−124
   and, to have good magnetic permeability, the Cr, Mo and Ni contents have to be such that:
   4×(Cr+Mo)≧125−3×Ni;
optionally up to 2% of niobium to increase the mechanical strength;
less than 0.35% and preferably more than 0.05% of manganese and less than 0.20% and preferably less than 0.15% of silicon. These elements are required for production, but the inventors have found, in a novel manner, that, by limiting the contents of these elements, the magnetic permeability at 300 Hz, μ_{300 Hz}, is substantially increased, even with oxygen contents which may be as high as 0.0160%;
less than 0.0500% of carbon, less than 0.0020% of sulphur, less than 0.0010% of boron, less than 0.0200% of nitrogen and less than 0.0160% of oxygen. These limits to the contents of impurities enable high magnetic permeability to be obtained. It should be noted, however, that the oxygen content may be more than 0.0050%, without adversely affecting the magnetic properties, and this enables the alloy to be produced more easily and more economically, which is desirable;
optionally magnesium or calcium in amounts of which the sum may be as high as 0.1000% and must preferably be less than 0.0500%, but more than 0.0010%, in order to form magnesium or calcium oxides which facilitate the mechanical cutting of parts in strips.

The remainder of the composition is iron and optionally impurities.

Using this alloy, strips are produced, for example, by hot rolling then cold rolling. At the final thickness, the strips are subjected to annealing at least at 1050° C. and preferably at more than 1100° C., also preferably in a hydrogen reducing atmosphere or in a mixture of steam and hydrogen. After annealing, cooling to ambient temperature preferably has to be carried out at slow speed, in other words necessitates more than 1 hour to be able to reach 200° C. in order to optimize the magnetic permeability at 300 Hz.

The following magnetic properties are obtained in the strips obtained in this way and also having a thickness of 0.4 mm:
μ_{300 Hz}>15000
μ_{cc}>40000
Bs>4000 G
Hc<100 mOe

These properties allow production of magnetic shielding which is very effective in low-frequency fields, but also in direct fields (for example, terrestrial field).

As an example, the alloys designated 1 to 21 according to the invention were produced and the alloys designated 22 to 32 were provided as a comparison. The compositions and the properties of these alloys are shown in Tables 1 and 2, and the magnetic properties of the alloys are shown in Tables 3 and 4.

The magnetic properties were measured on 0.6 mm thick strips in the case the coercive fields Hc, expressed in mOe, and in the case of permeability in a direct field gcc which was measured at 0° C. and at 40° C. The saturation induction Bs, expressed in Gauss, was measured at 40° C. The magnetic permeability in an alternating field at 30 Hz, μ_{300 Hz}, was measured at 40° C. on 0.4 mm thick strips. The alloys were produced under vacuum in an induction furnace then cast in the form of hot-rolled then cold-rolled ingots to provide strips from which samples were cut and were then annealed for four hours at 1170° C. under pure dry hydrogen, with rapid cooling if they were intended to measure permeability in a direct field and slow cooling if they were intended to measure permeability in an alternating field.

Alloys 1 to 21 all have a coercive field of substantially less than 100 mOe, permeability in a direct field of more than 40000, at both 0° C. and 40° C., permeability in an alternating field at 300 Hz of more than 15000 and saturation induction of more than 4000 G.

TABLE 1

| | In % by weight | | | | | | | | In ppm | | | | | |
|---|---|---|---|---|---|---|---|---|---|---|---|---|---|---|
| Item | Ni | Cr | Mo | Co | Cu | Mn | Si | Nb | C | S | P | N | O | B |
| 1 | 38.94 | 9.14 | <0.005 | 0.042 | 0.022 | 0.323 | 0.163 | traces | 65 | 13 | 41 | 28 | 67 | <10 |
| 2 | 36.52 | 9.02 | 0.0057 | 0.065 | 0.020 | 0.315 | 0.168 | traces | 55 | 14 | 43 | 27 | 80 | <10 |
| 3 | 36.88 | 9.04 | <0.005 | 0.044 | 0.022 | 0.310 | 0.155 | traces | 45 | 14 | 43 | 27 | 100 | <10 |
| 4 | 37.64 | 6.98 | <0.005 | 0.005 | 0.017 | 0.333 | 0.144 | traces | 45 | 14 | <30 | 13 | 93 | <10 |
| 5 | 33.66 | 7.95 | — | — | — | 0.188 | <0.01 | — | 41 | 9 | 34 | 29 | 120 | <10 |
| 6 | 33.55 | 8.17 | <0.005 | 0.014 | <0.01 | 0.172 | 0.016 | traces | 160 | <5 | <30 | 21 | 35 | <10 |
| 7 | 37.63 | 9.31 | 0.023 | 0.503 | 0.094 | 0.293 | <0.01 | 0.007 | 86 | 8 | <30 | 27 | 90 | <10 |
| 8 | 37.95 | 9.56 | 0.0056 | 1.42 | 0.020 | 0.289 | 0.017 | traces | 83 | 9 | <30 | 30 | 84 | <10 |
| 9 | 37.86 | 10.55 | <0.005 | 0.962 | 0.018 | 0.299 | 0.019 | traces | 49 | 10 | <30 | 27 | 140 | <10 |
| 10 | 39.49 | 9.6 | 0.0097 | 1.02 | <0.01 | 0.287 | 0.021 | 0.006 | 96 | 10 | 30 | 29 | 29 | <10 |
| 11 | 37.75 | 9.54 | — | 1.02 | — | 0.300 | — | — | 91 | 6 | <20 | 6.6 | 62 | <10 |
| 12 | 37.66 | 9.19 | <0.005 | 1.02 | <0.01 | 0.178 | 0.105 | traces | 150 | 6 | <30 | 14 | 25 | <10 |
| 13 | 35.8 | 9.05 | — | 1.04 | — | 0.300 | — | — | 83 | <5 | <20 | <5 | 99 | <10 |
| 14 | 35.7 | 9.17 | <0.005 | 1.03 | <0.01 | 0.173 | 0.111 | traces | 130 | <5 | <30 | 12 | 64 | <10 |
| 15 | 35.77 | 5.6 | <0.005 | 1.01 | <0.01 | 0.306 | 0.035 | traces | 94 | <5 | 40 | 8.3 | 75 | <10 |
| 16 | 37.74 | 5.76 | <0.005 | 0.969 | <0.01 | 0.308 | 0.033 | traces | 92 | <5 | 38 | 7.5 | 58 | <10 |
| 17 | 35.85 | 5.89 | <0.005 | 2.85 | <0.01 | 0.308 | 0.031 | traces | 83 | <5 | 34 | 5.5 | 52 | <10 |
| 18 | 35.79 | 8.92 | — | 3.03 | — | 0.290 | — | — | 90 | <5 | <20 | 9.6 | 69 | <10 |
| 19 | 37.77 | 5.8 | 0.0086 | 2.87 | <0.01 | 0.298 | 0.033 | traces | 69 | <5 | 37 | 8.8 | 83 | <10 |
| 20 | 37.45 | 8.72 | — | 3.06 | — | 0.300 | — | — | 89 | <5 | <20 | 12 | 68 | <10 |
| 21 | 31.84 | 8.23 | <0.005 | 3.07 | <0.01 | 0.174 | 0.013 | traces | 150 | 6 | <30 | 10 | 19 | <10 |

Alloys 22 to 32, given as a comparison, show the significance of the limits imposed on the chemical composition.

TABLE 2

| | By % weight | | | | | | | | In ppm | | | | | |
|---|---|---|---|---|---|---|---|---|---|---|---|---|---|---|
| Item | Ni | Cr | Mo | Co | Cu | Mn | Si | Nb | C | S | P | N | O | B |
| 22 | 31.84 | 8.2 | <0.005 | 0.011 | <0.01 | 0.173 | 0.018 | traces | 150 | 5 | <30 | 10 | 24 | <10 |
| 23 | 33.46 | 4.88 | 0.014 | 0.014 | 0.011 | 0.133 | 0.018 | traces | 66 | 11 | <30 | 19 | 94 | <10 |
| 24 | 33.78 | 2.02 | 2.03 | traces | <0.01 | 0.186 | <0.01 | traces | 150 | <5 | <30 | 10 | 13 | <10 |
| 25 | 33.78 | 0.019 | 2.21 | traces | <0.01 | 0.183 | <0.01 | traces | 130 | <5 | <30 | 10 | 34 | <10 |
| 26 | 37.69 | 3.14 | <0.005 | 1.06 | <0.01 | 0.296 | 0.031 | traces | 90 | <5 | 35 | <5 | 57 | <10 |
| 27 | 33.7 | 8 | — | 2.07 | — | 0.187 | <0.01 | traces | 66 | 15 | 38 | 7 | 180 | <10 |
| 28 | 33.96 | 2.64 | <0.005 | 1.96 | <0.01 | 0.259 | 0.032 | — | 89 | <5 | 35 | 5.1 | 85 | <10 |
| 29 | 33.83 | 5.1 | <0.005 | 2.02 | <0.01 | 0.152 | <0.01 | traces | 67 | 7 | <30 | 7.2 | 110 | <10 |
| 30 | 31.68 | 8.03 | 0.027 | 0.01 | 2.97 | 0.176 | 0.018 | traces | 120 | 7 | 31 | 54 | 67 | <10 |
| 31 | 30.14 | 2.09 | <0.005 | traces | 2.99 | 0.193 | <0.01 | 0.005 | 130 | <5 | <30 | 10 | 29 | <10 |
| 32 | 32.29 | 1.87 | 0.082 | traces | 3.92 | 0.166 | 0.014 | 0.007 | 83 | 9 | 35 | 7.6 | 86 | <10 |

Alloy 22 has a chromium content which is too high to satisfy the conditions Cr+Mo≦0.8×Ni+0.9×(Co+Cu)−18.4 and Cr+Mo≦4×Ni+3×(Co+Cu)−124, and its saturation induction is very low.

Alloys 23, 24, and 25 have chromium contents which are too high to satisfy the condition 4×(Cr+Mo)≧125−3×Ni, and their permeability in a direct field is substantially less than 40000.

Alloy 26 does not satisfy the relationship Cr≧5%, and its permeability in an alternating field at 300 Hz is substantially less than 15000.

Alloy 27 has an oxygen content of more than 160 ppm and its permeability in a direct field is substantilly less than 40000.

Alloys 28 and 29 do not satisfy the relationship 4×(Cr+Mo)≧125−3×Ni, and alloy 28 does not satisfy the condition Cr≧5%. On the one hand, their permeability in a direct field is substantially less than 40000, but, in particular, their permeability in an alternating field is substantially less than 15000.

Alloy 30 does not satisfy the conditions Cr+Mo≦0.8×Ni+0.9×(Co+Cu)−18.4 and its permeability in a direct field is substantially less than 40000.

Alloy 31 does not satisfy the conditions Cr+Mo≦4×Ni+3×(Co+Cu)−124 and 4×(Cr+Mo)≧125−3×Ni, and its magnetic permeability is inadequate in both an alternating field and a direct field.

TABLE 3

| | Magnetic properties | | | | |
|---|---|---|---|---|---|
| Item | Hc | Bs | μ_{cc} 0° C. | μ_{cc} 40° C. | μ_{300 Hz} |
| 1 | 28 | 6800 | 61400 | 62400 | 17900 |
| 2 | 23 | 5500 | 64000 | 50300 | 23200 |
| 3 | 22 | 6000 | 69000 | 59600 | 21700 |
| 4 | 39 | 8100 | 69200 | 67200 | 21100 |
| 5 | 18 | 4500 | 47500 | 44700 | 17800 |
| 6 | 10 | 4200 | 80300 | 72000 | 16000 |
| 7 | 22 | 6500 | 67600 | 67400 | 21400 |
| 8 | 26 | 6700 | 66800 | 64700 | 19100 |
| 9 | 22 | 5600 | 48100 | 77200 | 20800 |
| 10 | 21 | 7200 | 72600 | 72100 | 18600 |
| 11 | 22 | 6800 | 98300 | 93000 | 18500 |
| 12 | 14 | 6800 | 132900 | 118300 | 22000 |
| 13 | 24 | 5700 | 71500 | 66900 | 22100 |
| 14 | 22 | 5700 | 86900 | 78900 | 22400 |
| 15 | 44 | 8400 | 42700 | 57100 | 17900 |
| 16 | 34 | 9500 | 74900 | 93400 | 19400 |
| 17 | 45 | 9100 | 52500 | 60500 | 17000 |
| 18 | 27 | 6700 | 84200 | 97600 | 19100 |
| 19 | 44 | 10000 | 48100 | 68200 | 17600 |
| 20 | 25 | 7500 | 91900 | 84100 | 20800 |
| 21 | 13 | 4700 | 51600 | 65000 | 17900 |

TABLE 4

| | Magnetic properties | | | | |
|---|---|---|---|---|---|
| Item | Hc | Bs | μ_{cc} 0° C. | μ_{cc} 40° C. | μ_{300 Hz} |
| 22 | 7 | 500 | 45800 | — | 13600 |
| 23 | 36 | 7000 | 24200 | 29100 | 14400 |
| 24 | 28 | 7400 | 33300 | 31900 | 14200 |
| 25 | 33 | 8200 | 29100 | 26600 | 14100 |
| 26 | 54 | 11700 | 48200 | 59200 | 13700 |
| 27 | 32 | 5900 | 26600 | 37600 | 20000 |
| 28 | 85 | 10200 | 18000 | 22900 | 10800 |
| 29 | 69 | 8400 | 14100 | 21300 | 13000 |
| 30 | 26 | 4700 | 31700 | 32200 | 15300 |
| 31 | 33 | 6500 | 20500 | 21400 | 11100 |
| 32 | 73 | 10400 | 12500 | 18100 | — |

Alloy 32 does not satisfy the conditions 4×(Cr+Mo)≧125−3×Ni, and its magnetic permeability is very inadequate.

1. Magnetic shielding for frequency fields between 50 Hz and 3000 Hz, made from a soft magnetic alloy of the following composition in % by weight:
30%≦Ni≦40%
0%≦Cu+Co≦4%
5%≦Cr+Mo≦17%
5%≦Cr
0%≦Nb≦2%
Mn≦0.35%
Si≦0.2%
C≦0.050%
O≦0.0160%
S≦0.0020%
B≦0.0010%
optionally at least one element selected from magnesium and calcium in amounts such that the sum thereof remains below 0.1%, the remainder being iron and production impurities, the chemical composition furthermore satisfying the following relationship:
Cr+Mo≦0.8×Ni+0.9×(Co+Cu)−18.4
Cr+Mo≦4×Ni+3×(Co+Cu)−124
4×(Cr+Mo)≧125−3×Ni.

2. Shielding according to claim 1, further characterised in that:
Si≦0.15%.

3. Shielding according to claim 1, further characterised in that:
Mn≧0.05%.

4. Shielding according to claim 1, further characterised in that:
Co+Cu≧0.015%.

5. Shielding according to claim 1, further characterised in that:
O≧0.0050%.

6. Use of a soft magnetic alloy of which the composition is as defined in claim 1, for the production of magnetic shielding for frequency fields between 50 Hz and 3000 Hz.
